(19) United States
(12) Patent Application Publication
(10) Pub. No.: US 2013/0036731 A1
(43) Pub. Date: Feb. 14, 2013

(54) MODULE FOR RECOVERING ENERGY FROM MARINE AND FLUVIAL CURRENTS

(71) Applicant: Yves Kerckove, Pegomas (FR)

(72) Inventor: Yves Kerckove, Pegomas (FR)

(21) Appl. No.: 13/577,239

(22) PCT Filed: Feb. 8, 2011
(86) PCT No.: PCT/FR11/00076

§ 371 Date: Oct. 26, 2012

(30) Foreign Application Priority Data
Feb. 9, 2010 (FR) 1000513
Jun. 3, 2010 (FR) 1002348

(51) Int. Cl. F03B 13/22

(52) U.S. Cl. 60/496; 60/495

(57) ABSTRACT

The present invention relates to a module for recovering energy contained in marine and fluvial currents comprising: at least one hydrodynamic float (1), at least one energy generator comprising at least one turbine (8) provided with blades, at least one holder (2) of the power generator, at least one cable or buoy rope (4) tethered to at least one attachment point (6) on the module and attached to a mooring (5) for positioning the module in the direction of the current and in a predetermined space, characterized in that said module includes at least one ballasted keel (3) providing module stability, and in that said power generator is kept under the float (1) by the support (2) in such a manner that the height which separates the end of the keel (3) from the axis of rotation of the turbine (8) is at least 20% of the height (h2) between the axis of rotation of the turbine (8) and the lower surface of the float (1). The invention is used for recovering energy from marine and fluvial currents. The module according to the invention is configured to work on the surface, in the pelagic zone, or close to the bottom.

This invention aims at producing electricity or any other energy by recovering energy from marine and fluvial currents and energy from tidal currents, by means of hydroelectric or any other turbines.

This invention will be able to work in fresh water, in a river, in streams, but is more particularly planned for a marine environment. The invention is configured to work on the surface, in the pelagic zone, or close to the bottom.

Several technologies are currently known:

HYDROHELIX Project: this project comprises turbines for collecting fluvial energy. This project is very different from the invention: a significant fixed infrastructure is required. Returns on investment take much time.

HAMMERFEST Stroen Project: (Norway). This concerns a park of marine current turbines, which look like wind turbines permanently fixed on the bottom of the sea. A lot of problems of maintenance must occur. There has been little emulation.

OCEAN POWER project: uses another technology, the one recovering wave energy.

PELAMIS project: it concerns an assembly of cylinders laid on the surface of the sea and mounted end to end. It recovers wave energy. This method is very fragile and a return on investment is said to be of the order of 30 years.

WAVE DRAGON Project: It looks like a wave trap. It also looks a little bit like an anti-black tide barrier.

Patent WO 2007148120 by Goodredge Robin discloses a totally different device, more particularly as regards the four tethering cables, since the device cannot navigate. It only floats. It should also be noted that:

turbulences and cavitation will occur in front and behind, thus preventing any production of power, since it has no hydrodynamic profile.

nothing is provided for placing the turbines parallel with the current wire; misunderstanding of whirls and change of direction of marine currents, according to changes in temperature, moon cycles, differences in atmospheric pressure, wind, etc.

The need therefore exists for a device having an improved hydrodynamism and a better stability in currents.

For this purpose, the present invention relates to a module for recovering energy contained in marine and fluvial currents.

This invention comprises five parts:

The float (1)

The support (2) of hydroelectric generators comprising for instance a turbine or similar,

The keel or keels (3)

The buoy ropes (4)

The attachment means, as moorings (5)

Said power generator is kept under the float by the support in such a manner that the height which separates the end of the keel from the axis of rotation of the turbine is at least 20% of the height between the axis of rotation of the turbine and the lower surface of the float.

The device of the invention has currently no competitor on the market.

It can be put forward that it is: versatile, universal, economical, industrial, since it can be manufactured everywhere and provide a return on investment in less than 5 years.

The invention can work in the pelagic zone, at any depth.

But, of course, the deeper it will go, the more complicated the pressure issues (thicker steel sheets, leaking joints) and the maintenance issues will be, but they will be solved. This device may be equipped with fixed or mobile means for adjusting the buoyancy thereof and for placing the axis of the turbine parallel with the stream, even though the stream is not straight. If such means are mobile, these shall be servo-controlled by microprocessors, an attitude data generator, a GPS, a depth level control, etc . . . )

The present invention relates to a module for recovering energy contained in marine and fluvial currents comprising:
at least one hydrodynamic float (1)
at least one energy generator comprising at least one turbine (8) provided with blades,
at least one support (2) of the power generator,
at least one cable or buoy rope (4) tethered to at least one attachment point (6) on the module and attached to a mooring (5) for positioning the module at sea or in a river, in such manner that it is positioned in the direction of the current and with the stream, and in a predetermined space, characterized in that said module comprises at least one ballasted keel (3) providing module stability, and in that said power generator is kept under the float (1) by the support (2) in such a manner that the height (h1) which separates the end of the keel (3) from the axis of rotation (13) of the turbine (8) is at least 20% of the height (h2) between the axis of rotation (13) of the turbine (8) and the lower surface (14) of the float (1).

According to preferred alternative, but non-limiting solutions of the invention, the module is such that:
the height which separates the centre of inertia of the keel and the axis of rotation of the turbine is at least 20% of the height between the axis of rotation of the turbine and the lower surface of the float,
the keel is offset with respect to the power generator in such a manner that the longitudinal axis of the keel is offset with respect to the axis of rotation of the turbine,—the centre longitudinal axis of the keel is positioned substantially parallel to the axis of rotation of the turbine,
the keel is positioned substantially perpendicular to the turbine blades,
the width which separates the keel from the axis of rotation of the turbine is at least equal to the height between the axis of rotation of the turbine and the lower surface (14) of the float,
the keel comprises, at the free end thereof, a ballast for receiving a variable volume of water, comprises a plurality of power generators positioned in one or several stacked horizontal row(s), comprises a plurality of buoy ropes attached on attachment points distributed over the whole of the module and gathered into a single main buoy rope enabling the anchoring of the module,
the main buoy rope is attached to a mooring by means of a link configured in such a manner as to enable the rotation of the main buoy rope with respect to the mooring,

the mooring is made of preferably cellular concrete, or any other tethering means.
the float comprises an antenna for transporting the energy generated by the power generator outside the module,
the float comprises an outlet for the energy generated by the lower surface thereof, preferably along a buoy rope,
the keel comprises at least a horizontal rudder configured in such a manner as to enable the variation of the depth of the module,
it comprises means for modifying the length of a buoy rope.

Another object of the present invention is a module for recovering energy contained in marine and fluvial currents which can work on the surface, in the pelagic zone, or close to the bottom. Characterized in that it comprises five main elements: an aircraft-wing shaped hydrodynamic float, a support for power generators, at least one ballasted keel providing module stability, cables or buoy ropes tethered on the attachment points and gathered into only one bigger buoy rope, which in turn will be attached to a mooring, with said mooring being preferably made of concrete, or any other anchoring means enabling to position said module at sea or in a river, in such a manner that it can be positioned in the direction of the current and in the stream, in a predetermined space.

Optionally, the module may comprise at least any one of the optional characteristics mentioned in the optional or additional alternative solutions above, or hereinunder:
A module as described hereabove, characterized in that the attitude data generator, the control generator enabling to manage the various navigation and control, signalling and geolocalization devices, and the device for draining the energy produced are installed inside the float.
A module as described hereabove, characterized in that the float is provided with centreboards.
A module as described hereabove, characterized in that the support of power generators is intended for receiving one or several energy collector(s) positioned in one or several horizontal row(s), in that it has a hydrodynamic profile and it is fixed to the float, and more particularly welded thereto.
The module as described hereabove, characterized in that the energy recovering means are hydroelectric turbines
A module as described hereabove, characterized in that it comprises one or several ballasted keel(s), comprising fixed or mobile stabilization means, side boards and servo-controlled or not horizontal rudders, and providing module stability.
A module as described hereabove, characterized in that it comprises a plurality of buoy ropes attached on attachment points distributed over the whole of the module and gathered into a single main module enabling the anchoring of the module on the bottom of the sea, with said buoy ropes being selected among the group consisting in cables, chains, multi-stand cables, rigid rods, and being designed to be as short as possible.
A module as described hereabove, characterized in that the mooring is fixed on the main buoy rope by a link enabling rotation and in that it is made of cellular or not concrete, to be used as fish nurseries.
A module as described hereabove, characterized in that the components are made of mechano-welded steel and reinforced polyester.
An assembly for recovering energy from marine and fluvial current comprising a plurality of modules, such as described hereabove, characterized in that it is made of a supporting assembly shaped as a lattice of cables and/or rigid bracers, at the crossing of which buoy ropes holding the modules, are attached, with said assemblies being tethered on the bottom, using cable and mooring means. They comprise lifting buoys, balancing ballasts, spacing boards, positioned temporarily or permanently. They are connected to means for storing or transferring the produced energy by electric cables or pipelines
An assembly for recovering energy from marine and fluvial currents, also called “farms” comprising modules, with said modules being tethered on the bottom using cable and mooring means. They are connected to means for storing or transferring the produced energy by electric cables or pipelines.

Other characteristics, aims and advantages of the present invention will appear upon reading the following detailed description and referring to the appended drawings given as non limiting examples and wherein:

FIG. 1 shows a front view of a module according to one embodiment of the invention.

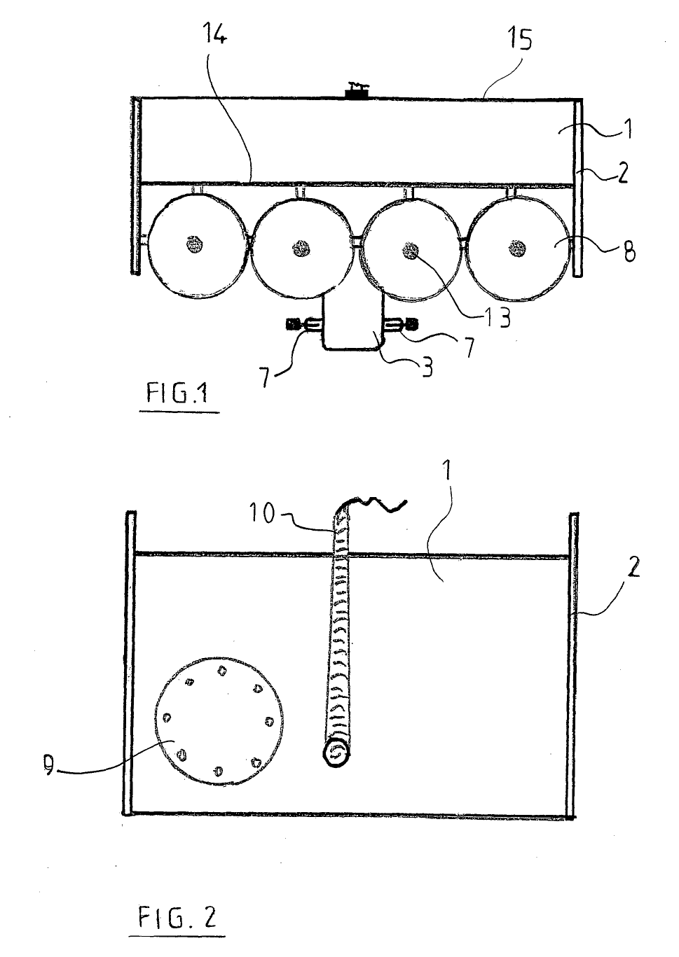

FIG. 2 is a top view of the module of FIG. 1.

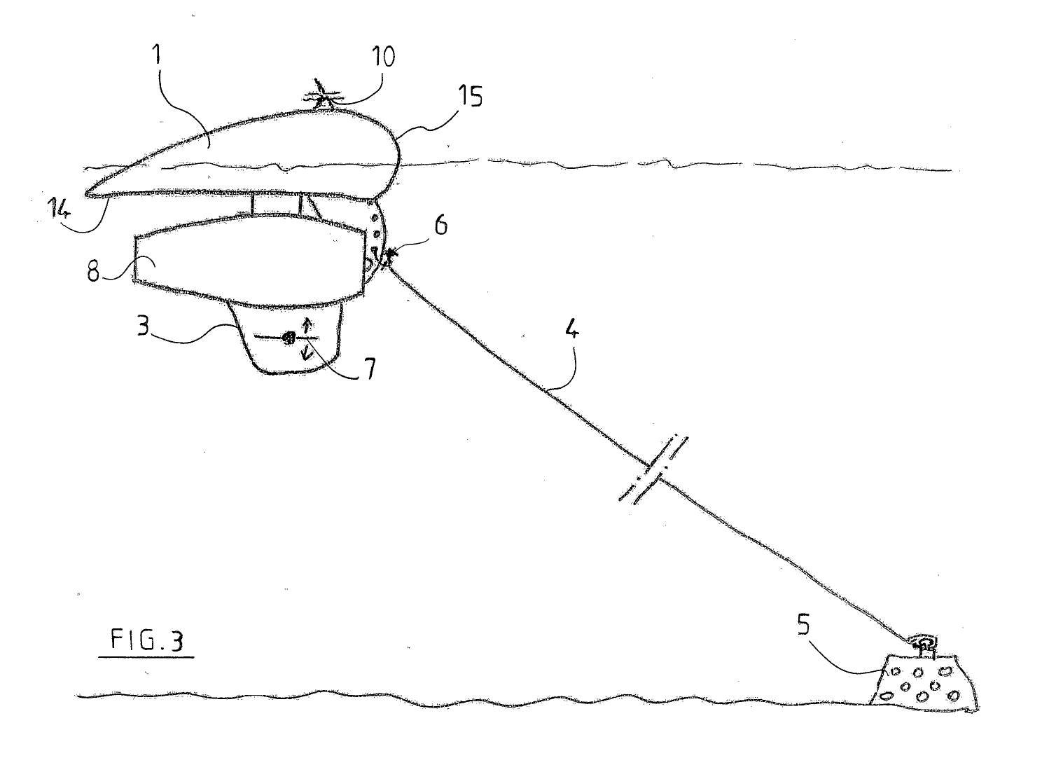

FIG. 3 illustrates a side view of the module according to the invention.

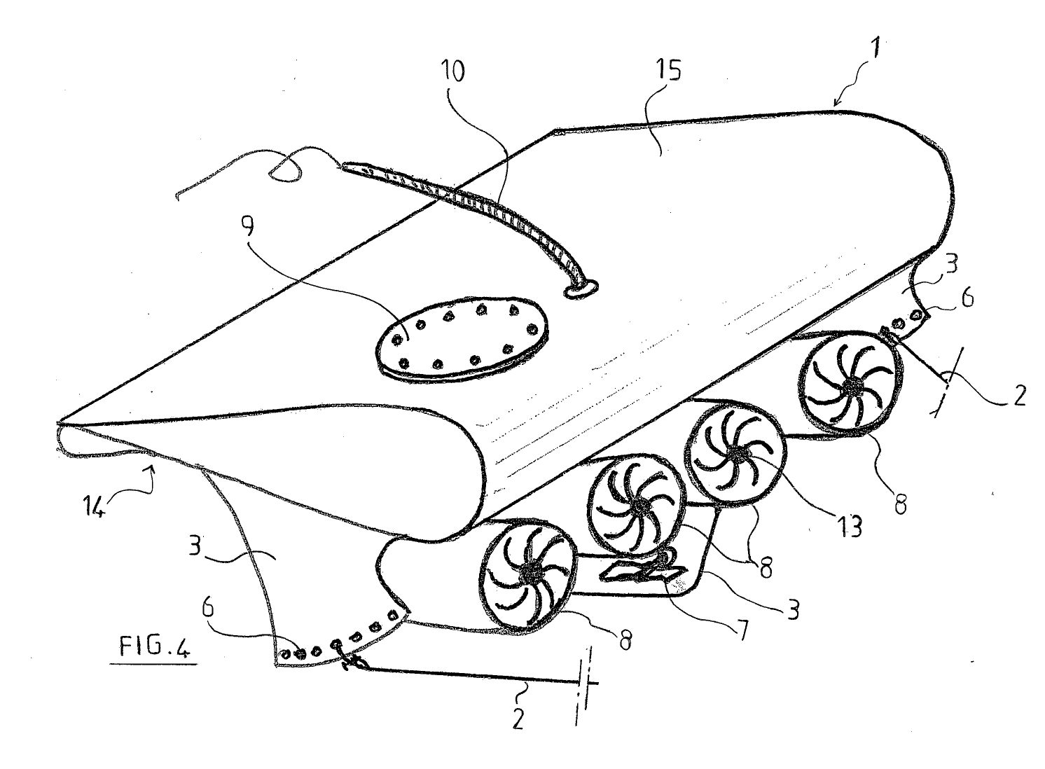

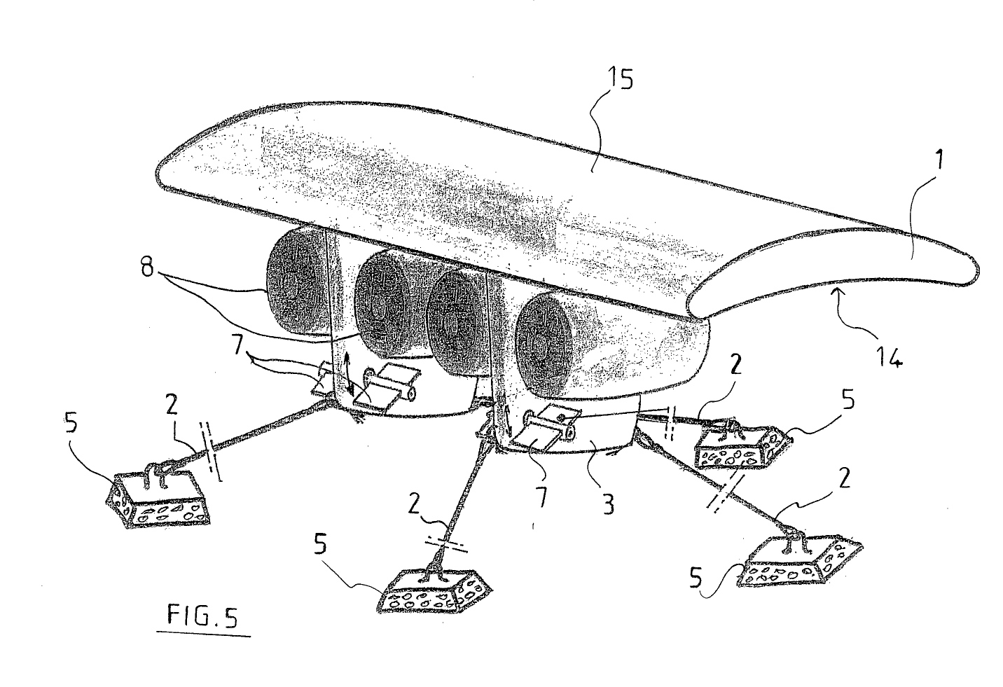

FIGS. 4 and 5 show a perspective view of a module according to the invention according to two possible attachment points respectively by the support of the power generator and by the keels.

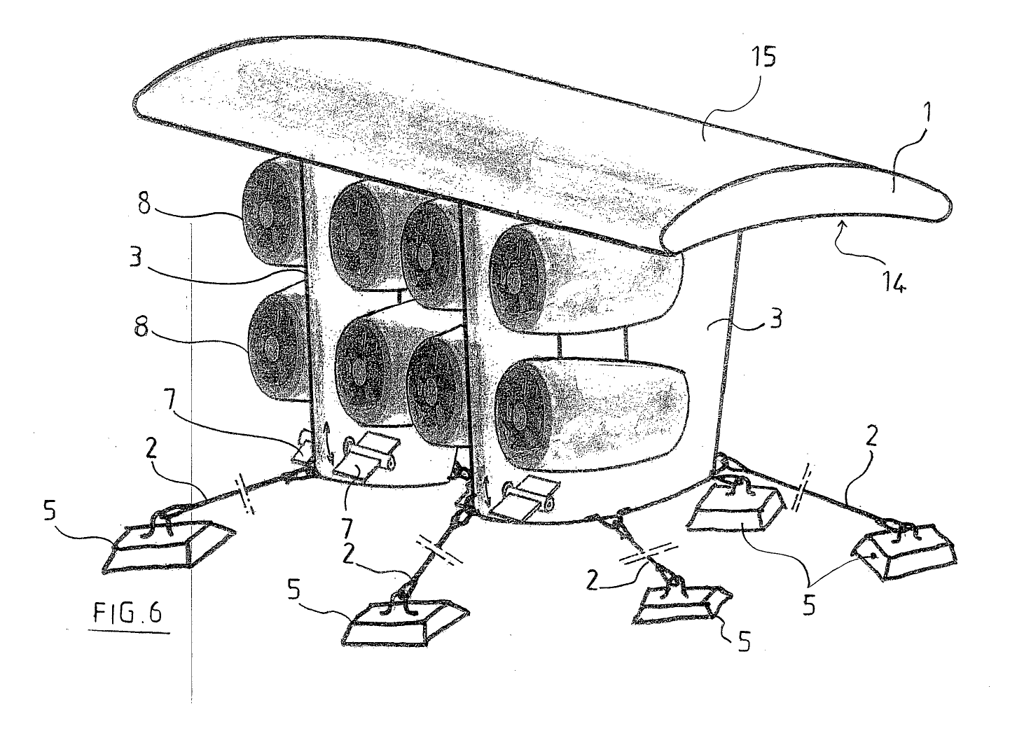

FIG. 6 shows a perspective view of a module according to another embodiment of the invention wherein several power generators are positioned in two rows stacked under the float.

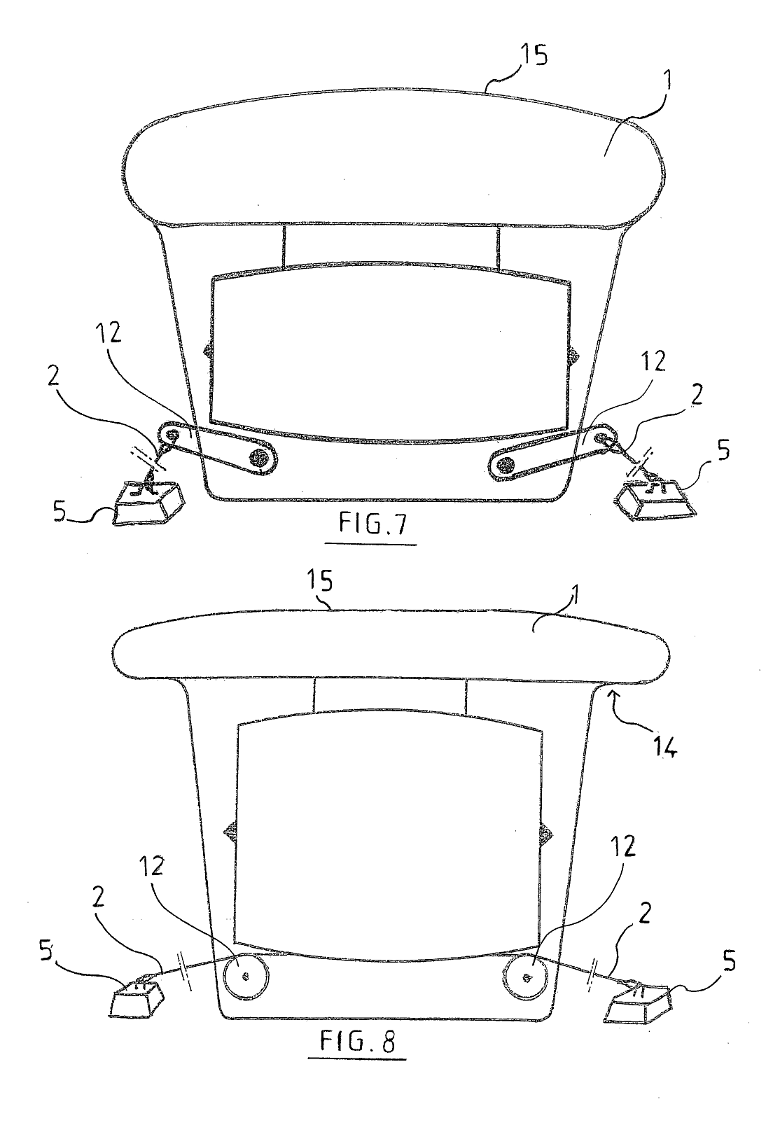

FIGS. 7 and 8 show two embodiments of anchoring points for a module according to the invention.

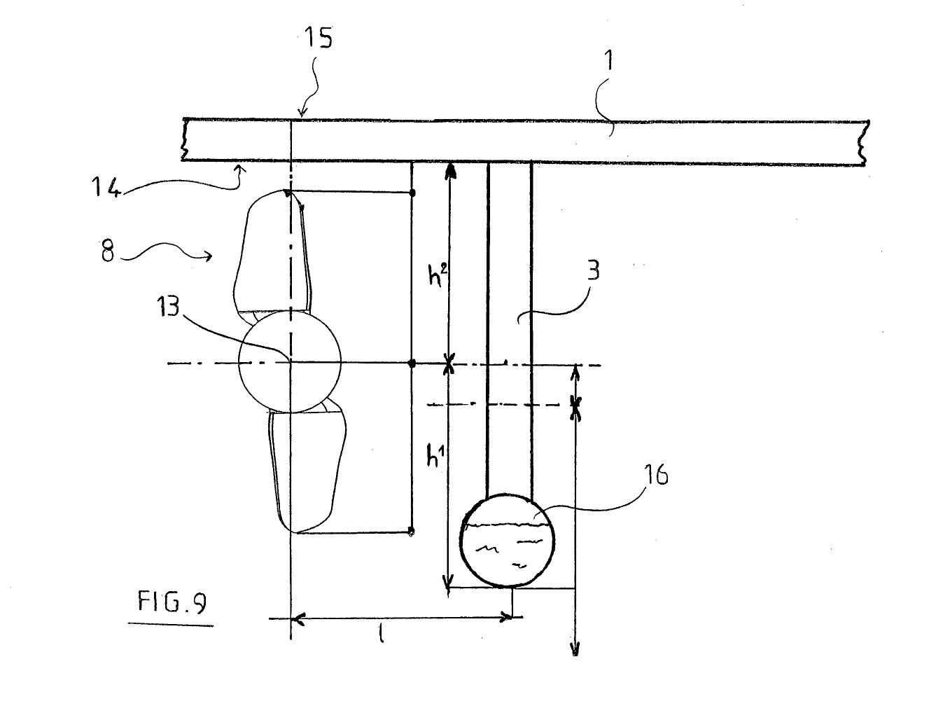

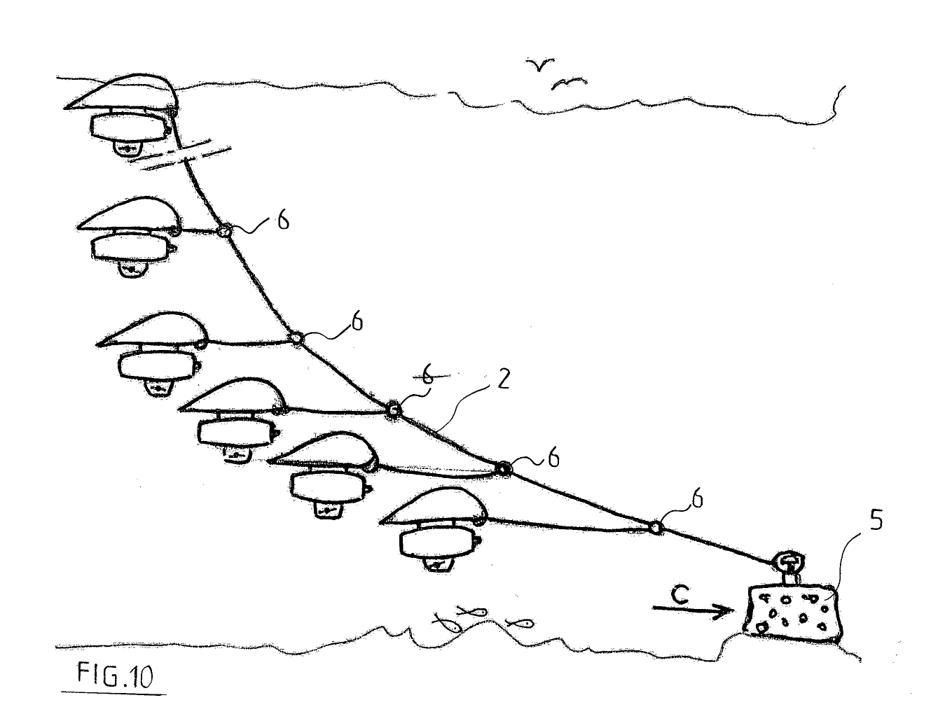

FIG. 9 shows the positioning of a power generator with respect to the keel and to the float.

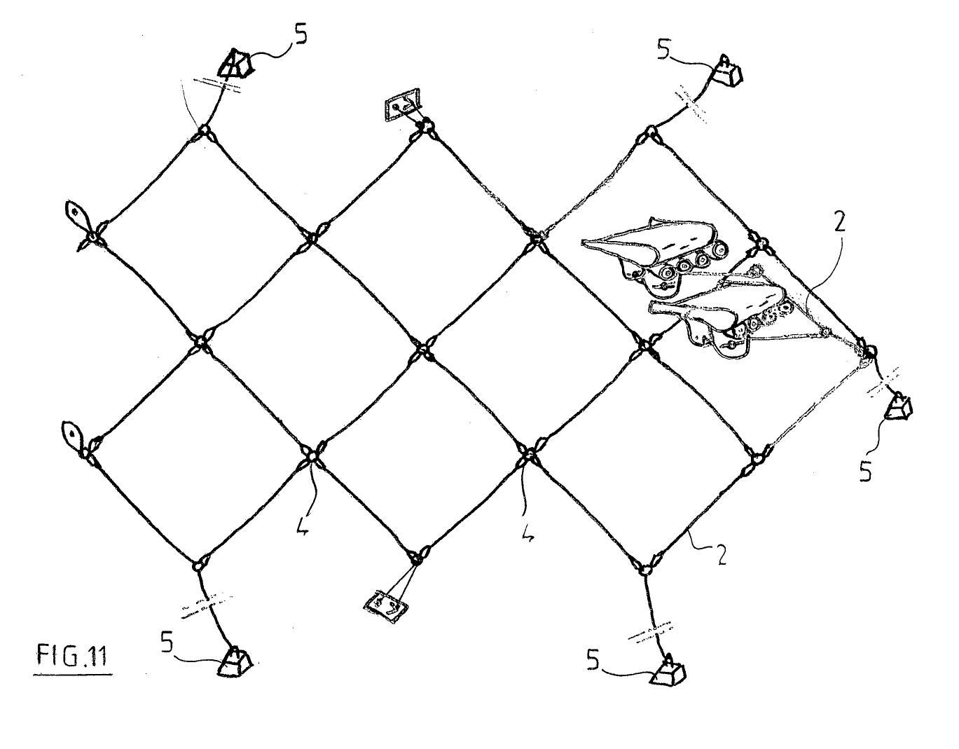

FIGS. 10 and 11 illustrate two embodiments of the invention, wherein several modules are associated together.

The module comprises at least one float 1 composed of a mechano-welded or polyester assembly which can be made of any type of material known or to be known. The float 1 is of the “aircraft wing” type. Like aircraft wings, it can have different shapes, so as to obtain the best hydrodynamic performances and more particularly in a current flowing in both directions, such as tidal currents, as well as the best compatibility with the support of the power generator.

The float 1 may be a tank or a buoy containing a material having a density enabling the float 1 to float. Floating means that the module is positioned at the surface of water or at mid-water level.

Advantageously, the float 1 comprises an upper surface 15 facing the surface of water and a lower surface 14 facing the bottom. The upper surface 15 and the lower surface 14 may have several convex and/or concave and/or sinusoidal and/or plane shapes.

After modelling and simulation tests, tests in basins, like Ifremer's, will enable us to select the best profile.

For example, the attachment points 6 are provided on the float 1, and completed or not by those provided on other places on the module. The attachment points 6 are preferably positioned at the front of the module, i.e. at the front of the power generator.

The following devices are advantageously installed in this float 1: an attitude data generator, a centralized control of the management of module forces, the recovery of the produced energy, the management of the various navigation, and control, signalling and geolocalization devices, and the remote control and the device for draining the energy produced. One or several hatch(es) 9 shall be provided for access and maintenance purposes.

The module according to the invention also comprises at least one support for generators 2 or hydroelectric turbine(s), or any other device . . . Said support for generators is composed of an assembly made of mechano-welded steel or any other material, profiled to have a good hydrodynamic coefficient too. It shall be assembled with the float 1 by welding or any other mechanical means of the bolt, key, etc . . . types. The support for generators 2 is intended for receiving at least one power generator. The power generator advantageously comprises at least one hydroelectric turbine 8. The turbine 8 is provided with blades. The blades of the turbine can rotate about an axis of rotation 13. In the present description, the terms “axis of rotation 13 of the blades of the turbine 8” and “axis of rotation 13 of the turbine 8” will be used as equivalents. In an embodiment shown in FIGS. 1, 4, 5 and 6, several turbines 8 are positioned in one or several horizontal row(s). The rows of turbines 8 are then stacked.

The support of the generator 2 may also be provided with attachment points 6 for buoy ropes 4.

The module advantageously comprises at least one ballasted keel 3, balancing the module and supporting a vertical and a horizontal rudder 7. The keel 3 is preferably profiled too.

According to an alternative solution, attachment points 6 shall be attached to the keel 3 for anchoring the module with buoy ropes 4.

Rudders 7 shall be servo-controlled or not, and automatically driven, or not.

The keel 3 is advantageously assembled with the support of the power generator 2 and/or the float 1 by welding or some mechanical means.

Advantageously, the keel 3 has a longitudinal shape. It extends from the lower surface 14 of the float 1 toward the bottom of the sea or the river.

According to one alternative solution, the keel 3 is preferably provided with a ballast 18 able to receive a variable volume of water. As shown in FIG. 9, the ballast 16 is positioned at the free end of the keel 3.

In order to obtain a good hydrodynamic profile as well as a satisfactory stability in the current, and in spite of the turbulences created by the turbine 8, the keel 3 should advantageously extend beyond the axis of rotation 13 of the blades of the turbine 8. More precisely, the height h1 which separates the free end of the keel 3 and the axis of rotation 13 of the blades of the turbine 8 is at least equal to 20% of the height h2 between the axis of rotation 13 of the blades of the turbine 8 and the lower surface of the float 1. Free end of the keel 3 means the lower surface of the ballast 16 if it exists. Lower surface 14 of the float 1 means the lowest point of said surface 14.

Conventionally, the turbine 8 cooperates with an alternator for producing electricity. In a marine or fluvial environment, where the invention is used, upon rotating the turbine 8, the lack of means for holding the alternator on a fixed frame results in a rotation of the module assembly and the absence of production of power. The module may start to candle, and thus apply significant forces on attachment points of the module, which could result in the shearing thereof. The keel 3 according to the invention enables to create a counterweight and to remedy such drawbacks.

According to a preferred embodiment, the height which separates the centre of gravity of the keel 3 of the axis of rotation 13 is at least 20% of the height h2 between the axis of rotation 13 and the lower surface 14 of the float 1. More precisely, at least 50%.

The centre of gravity of the keel 3 is preferably located below the plane crossing the axis of rotation 13 of the blades of the turbine 8, more precisely between the end of the keel 3 and the plane crossing the axis of rotation 13 of the blades of the turbine 8.

In addition, or besides, the power generator and more particularly the turbine 8 may be mounted on the keel 3. However, the power generator and the keel are preferably mounted parallel. Then the power generator is attached to the lower surface 14 of the float 1, using a support 2 and the keel 3 is also attached to the lower surface 14 of the float 1. The power generator and the keel 3 are positioned side by side and face the current.

The power generator and the keel 3 are separated by a width at least equal to the height h2 which separates the lower surface 14 of the float 1 from the axis of rotation 13 of the turbine 8. More precisely, the axis of rotation 13 of the blades of the turbine 8 and the centre longitudinal plane of the keel 3 are taken into account.

The advantage to be searched for when assembling these pieces is how to provide the best maintenance solution: repair on site, standard replacement, etc.

Thanks to the invention, the production of current is never interrupted, since a module is detached to be repaired and another one is attached instead. Radio-guided robots must be able to carry out the attachments and detachments of the module.

The module according to the invention comprises buoy ropes 4 attached to the anchoring points 6 and advantageously gathered into only one bigger buoy rope.

The invention is more particularly characterized in that the only critical attachment points thereof are located in front of the module, when the latter faces the marine current, and in that it will work in said marine or fluvial current like a spoon lure for trout or pike fishing. The only links that could be added on the sides and the back could only be positioning buoy ropes in order to prevent it to hit a reef or another module.

The module must then have a hydrodynamic profile to be able to work this way. The buoy ropes attached to the attachment points shall thus be gathered into a single main buoy rope, which shall be attached to a mooring or to a supporting assembly.

The buoy ropes 4 are of the cable, chain, rod, etc. types. The buoy ropes 4 are intended for connecting the module according to the invention with moorings 5 or attachments at the bottom of the sea.

They can also be attached to supporting assemblies. Preferably, the buoy ropes 4 are as short as possible. The buoy ropes 4 will enable the module to float at the surface, in the pelagic zone or close to the bottom of the sea and to follow the stream as close as possible, in a predetermined space assigned thereto, either through the length of the buoy ropes 4, or through a servo-controlled or not geographic control (GPS, Galileo, or similar) and/or depth gauge.

The buoy ropes 4 selected among the cables, chains, multi-stand cables, rigid rods are attached on the attachment points 6 and will fall down to the bottom of the sea, together with the moorings 5. It shall thus be necessary to provide for buoy ropes 4 at the front and at the rear of the module. In swirling currents, additional side attachments shall be required.

The main buoy ropes 4 can be directly attached on the bottom of the sea or of the rivers, but moorings 5 are preferably provided for. Moorings 5 may be prefabricated, and for instance made of concrete. They shall comprise an attachment system enabling the module to rotate, more particularly in case of a positioning in turning tidal currents. Their size and weight shall be adapted to modules arranged individually or severally in farms, for instance, as for wind turbines. As the volume thereof is of little importance, the moorings can have cells, in such a manner that they can become fish nurseries. Their weight is the only thing to be retained as regards the required resistance, at a given time.

Advantageously, the module is provided with stabilizing means. To gain efficiency when producing power, the module must follow the stream perfectly. For this purpose, the module is equipped with an attitude data generator, which will be able, through a control centre, to control cylinders which will actuate positioning arms 12 (FIG. 7), which will complete the normal anchoring onto the keel 3. Another solution consists of a positioning by coupled or not winches (FIG. 8), which shall be controlled by the attitude data generator.

The aircraft wing shaped turbines 8 fixed under the float 1, and resting in the supports 2 can be unitary or multiple. The number and the type thereof will depend on the optimization of the construction, according to the depth of water, the speed of the current, the dimensions of the wing, the selection of the turbines. They shall be bought from specializing manufacturers or created for the purposes of the project.

Electricity, or any other type of energy, produced by the turbines 8 shall either be used on site, for example by a lighthouse, a buoy, a plant, a power-hydrogen production plant, but this is not a limitation, or it shall be transported by electric cables 10 or pipe-lines, to recovery centres or transported on shore, or to the utilization site. Other modes of transportation can be provided for other types of energy.

The module shall be able to work separately. According to a preferred embodiment, several modules are grouped in farms, as wind turbines presently are. Unlike wind turbines, they can work on several stages, or layers, in single file, frontally, on the whole width of the current, whether sea or fluvial current. Only one large electric cable or a pipe-line, for the other types of energy will be sufficient for transferring the electric current on shore. It can also be used or transformed on site.

In this embodiment, a supporting assembly is provided for. Tens, or hundreds, or even thousands of modules will be able to be tethered to this supporting assembly. The supporting assemblies will then be anchored at the bottom of the sea or the river by cables 4 and attached along the marine currents. The supporting assemblies may be made of cables, and also comprise rigid bracers. They may comprise lifting buoys, spacing boards similar to those of a trawl, etc.

Then, it shall be possible to work with module farms in currents located hundreds of kms off-shore. It shall also be possible to work, at the surface, in surface currents where sea is deep. A few big cables attached on the bottom of the sea with moorings 5 of a suitable weight, which will be sunk at the same time as said cables, with a geo-localization thereof will be sufficient. They will hold in position the supporting assemblies, a lattice made of small longitudinal and transversal cables located, for instance 50 m deep, and at the crossing of which the buoy ropes 4 holding the modules are attached. A temporary buoy is placed at each crossing and a mooring having a well-computed weight 5 is substituted for the buoy when the module, which shall not reach the bottom, is positioned. It shall balance the vertical stress from the module. Even better, actual plants can be founded in favourable places, away from a coast.

The present invention has been developed for an industrial mass- production, with components being manufactured in various places and assembled in a workshop located close to the site. It can even be expected that the various components will be assembled on a barge comprising a workshop, just prior to the launching. A barge could thus install several modules per day, and carry out maintenance operations. It can be expected that a barge will be permanently assigned to a farm, with lighters supplying the modules and the moorings 5.

After modelling a prototype, using, for instance Dassault's “CATIA” software and simulating the flow of fluids and the work of the existing hydro-electric generator using Dassault's “STIMULA”, or similar, testing in Ifremer's current basin will make it possible to validate the hydrodynamic performances of a prototype in a short time.

Production could soon be started and site testing could be carried out right afterwards, thus validating the starting up of industrial production. Firstly, modules with a 12 m front facing the current could be a good starting point for a mass production. This would make it possible to build sub-assemblies (turbine supporting wings, keels) with the often underused machine-tools currently available in the factories. Starting from this, we can expect to give mechano- welding work to a company in Saint-Etienne or Montlucon, and transport such sub-assemblies on trailer trucks, for instance to Le Havre, where the mounting plant would be located.

Industrial means required for the start-up (mass-production):
Sheet metal work: bending machines, rolling machines, welding, electro-galvanizing or cadmium plating, painting equipment or handling equipment (all this equipment is currently underused)
Hydroelectric turbines: the manufacturers are awaiting orders,
Control centres, servo-control centres, power recovery centres; everything is possible, but should be adapted.
Transportation: no problem.
Manufacturing of the “moorings”: reinforced concrete only.
Maritime means (barges, tugs); available means
Authorization to create power production marine farms; this is just a political issue, at a time when new sources of energy are searched for. However, should politicians not realize that the current problem is urgent, some industrialists would be ready to develop site beyond territorial waters.

If energy can be produced at lower costs, the future will see power-hydrogen production plants built on the open sea, thus bringing a new source of inexpensive energy. At present, the only limit to the mass-production of hydrogen is that the production costs thereof are greater than the selling price thereof.

We can expect that this invention will give work to millions of persons over several decades.

The extraction of the electricity produced is carefree in the case of modules located in established and unidirectional marine currents or in the rivers, but this is not true for the modules located in tidal currents. As a matter of fact, after slack low tide, flood tide carries on-shore before setting more or less clearly in its main direction. After slack high tide, ebb tide carries off-shore before setting. A perpetual rotating motion is thus created.

The extraction of the power produced shall then have to be provided through the apex of the module, using a waterproof antenna 10, rotating on 360°.

The draining can thus be provided along the anchoring buoy rope 2, using recovering buoys.

### REFERENCES

1. Float

2. Support of the generator

3. Keel

4. Buoy rope

5. Mooring

6. Attachment point

7. Rudder

8. Hydroelectric turbine

9. Access hatch

10. Antenna

11. Current

12. Positioning arm

13. Axis of rotation of the turbine blades

14. Lower surface of the float

15. Upper surface of the float

16. Ballast

h1. Height which separates the free end of the keel from the axis of rotation of the turbine h2. Height which separates the axis of rotation of the turbine from the lower surface of the float I. Width which separates the axis of rotation of the turbine from the keel.

1. A module for recovering energy contained in marine and fluvial currents comprising:
a hydrodynamic float,
an energy generator comprising a turbine provided with blades,
a holder of the power generator,
a cable or buoy rope tethered to an attachment point on the module and attached to a mooring for positioning the module in the direction of the current and in a predetermined space,
characterized in that it comprises a ballasted keel providing module stability, and in that said power generator is kept under the float by the support in such a manner that the height (h1) which separates the end of the keel from the axis of rotation of the turbine is at least 20% of the height between the axis of rotation of the turbine and the lower surface of the float.

2. A module according to claim 1, wherein the height between the centre of inertia of the keel and the axis of rotation of the turbine is at least 20% of the height (h1) between the axis of rotation of the turbine and the lower surface of the float.

3. A module according to claim 1, wherein the keel is offset with respect to the power generator in such a manner that the longitudinal axis of the keel is offset with respect to the axis of rotation of the turbine.

4. A module according to claim 1, wherein the keel is positioned substantially perpendicular to the turbine blades.

5. A module according to claim 1, wherein the width which separates the keel from the axis of rotation of the turbine is at least equal to the height (h2) between the axis of rotation of the turbine and the lower surface of the float.

6. A module according to claim 1, wherein the keel comprises, at the free end thereof, a ballast tank for receiving a variable volume of water.

7. A module according to claim 1 comprising a plurality of power generators positioned in one or several stacked horizontal row(s).

8. A module according to claim 1, comprising a plurality of buoy ropes tethered to attachment points distributed over the whole module and gathered into a single main buoy rope enabling the anchoring of the module.

9. A module according to claim 1, wherein the main buoy rope is attached to a mooring by means of a link configured in such a manner as to enable the rotation of the main buoy rope with respect to the mooring.

10. A module according to claim 1, wherein the mooring is made of concrete.

11. A module according to claim 1, wherein the float comprises an antenna for transporting the energy generated by the power generator outside the module.

12. A module according to claim 1, wherein the keel comprises a horizontal rudder configured in such a manner as to enable the variation of the depth of the module.

13. A module according to claim 1 comprising means for modifying the length of a buoy rope.
